(19) United States
(12) Patent Application Publication
(10) Pub. No.: US 2003/0208761 A1
(43) Pub. Date: Nov. 6, 2003

(54) Client-based searching of broadcast carousel data

(76) Inventors: Steven Wasserman, Mountain View, CA (US); James Armand Baldwin, Redwood City, CA (US); Peter T. Barrett, San Francisco, CA (US)

Correspondence Address: LEE & HAYES PLLC, 421 W RIVERSIDE AVENUE SUITE 500, SPOKANE, WA, 99201

(21) Appl. No.: 10/137,061

(22) Filed: May 2, 2002

(51) Int. Cl. H04N 5/445

(52) U.S. Cl. 725/53

(57) ABSTRACT

Client-based searching of carousel data that is broadcast from a carousel file system is described. The broadcast carousel data is segmented and individual segments are hashed according to a hashing function to produce hash index values that are representative of associated data segments. The hash index values are broadcast by the carousel file system to the client. When a viewer specifies a search, the client computes a hashed search query and compares it to the hash index values. When a match occurs, there is a possibility that the data segment associated with the matching hash index value might satisfy the query. Such data segments are identified and the client retrieves those data segments as they are broadcast from the carousel file system. The client is then able to perform searching on the data segments according to the viewer-specified search and present the results to the viewer.

### TECHNICAL FIELD

This invention relates to broadcast architectures (e.g., television entertainment architectures) that employ carousel servers to repeatedly broadcast data. More particularly, the invention relates to architectures in which a carousel server stores and broadcasts data (e.g., program data for an electronic program guide) in a manner that can be readily searched by a low-resource client (e.g., a low-resource set-top box).

### BACKGROUND

Electronic program guides (EPGs) enable TV viewers to navigate through an onscreen program guide and locate shows. With the guides, viewers can look at schedules of current and future programming, set reminders for upcoming programs, or enter instructions to record one or more shows.

A carousel file system is employed to repeatedly broadcast program data over a network to the client-based EPGs. The program data is stored in the client memory. The amount of program data available for the EPG is dependent upon the resource environment at the client. In a low-resource environment, meaning the client has limited memory and/or processing resources, the amount of memory reserved for program data and the ability to perform operations on the data, such as searching, are limited.

Accordingly, for such low-resource environments, there is a need for techniques to facilitate effective searching of EPG data where the client has limited processing and storage capabilities.

### SUMMARY

Client-based searching of carousel data that is broadcast from a carousel file system is described. In one implementation, the broadcast carousel data destined for a client is preprocessed and stored at a carousel file system. The data is segmented and individual segments are hashed according to a hashing function to produce hash index values that are representative of associated data segments. The hash index values are broadcast by the carousel file system to the client. When a viewer specifies a search, the client computes a hashed search query and compares it to the hash index values. When a match occurs, there is a possibility that the data segment associated with the matching hash index value might satisfy the query. Such data segments are identified and the client retrieves those data segments as they are broadcast from the carousel file system. The client is then able to perform searching on the data segments according to the viewer-specified search and present the results to the viewer.

### BRIEF DESCRIPTION OF THE DRAWINGS

FIG. 1 illustrates a broadcast architecture in the context of a television entertainment system that utilizes a carousel file system to broadcast program data to multiple clients.

FIG. 2 is a block diagram of the carousel file system.

FIG. 3 illustrates how a data file is reconstructed into a data structure that supports client-based searches of broadcasts carousel data.

FIG. 4 illustrates one implementation of computing searchable representations of data contained in the data file.

FIG. 5 is a block diagram of an exemplary client implemented as a set top box.

FIG. 6 is a flow diagram of an exemplary client-based searching process.

FIG. 7 illustrates a client screen user interface that can be employed to receive search terms entered by a viewer, and one possible allocation of client memory to store search results.

### DETAILED DESCRIPTION

The following discussion is directed to broadcast architectures that employ carousel file servers to repeatedly broadcast data to one or more clients. One particular example of such a broadcast architecture is a television entertainment system in which electronic program guide (EPG) data is broadcast over a network to clients. Representative television entertainment systems include broadcast TV, interactive TV, and Web-enhanced TV. Clients in such systems range from full-resource clients with substantial memory and processing resources (e.g., TV-enabled personal computers, TV recorders equipped with hard-disks) to low-resource clients with limited memory and/or processing resources (e.g., traditional set-top boxes). While aspects of the systems and methods described below can be used in any of these systems and for any types of clients, they are well suited for entertainment systems with low-resource clients.

Accordingly, the following discussion describes the systems and methods in the context of a television entertainment system in which EPG data is broadcast from a carousel file system to low-resource clients. However, the concepts are not limited to the television arena, but may be employed in other architectures in which carousel file servers are employed to serve other data files to low-resource clients.

Exemplary Broadcast Architecture

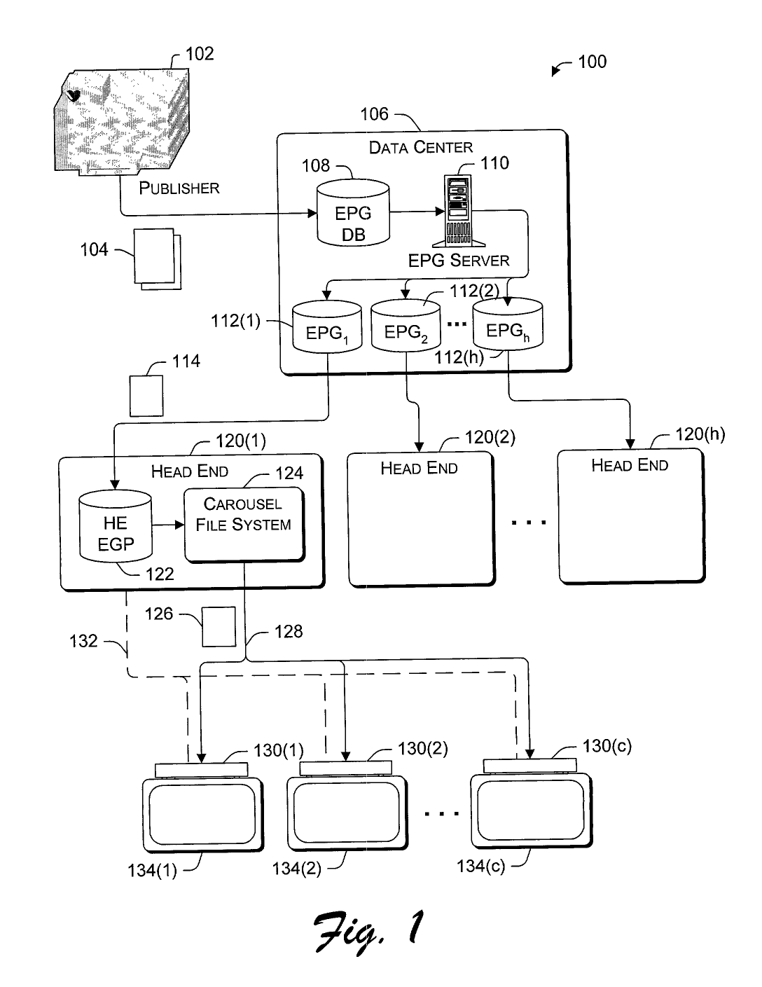

FIG. 1 shows an exemplary broadcast architecture implemented as a television entertainment system 100 that facilitates distribution of program data from a publisher to many viewers. In this context, program data refers to the type of data that might be used by an electronic program guide (EPG) and/or to facilitate interactive television functionality. Program data, or EPG data, includes program titles, ratings, characters, description, actor names, year made, station call letters, time schedules, channel numbers, and so on.

System 100 includes a publisher 102 that creates the EPG data. One example of a publisher 102 is the Tribune Corporation, which generates data for interactive television networks. The EPG data is transferred as an electronic file 104 from the publisher 102 to a data center 106. As one example, the program data 104 is transferred using a file transfer protocol (FTP) over a TCP/IP network (e.g., Internet, UNIX, etc.) to the data center 106. The electronic file 106 is stored in an EPG database 108 at the data center 106.

The original version of the EPG data contains all of the programming information for multiple days (e.g., 14 days). An EPG server 110 resides at the data center 106 to process the EPG data prior to distribution. With limited resources at the client, the processes performed by the EPG server 110 are helpful to precondition the EPG data into a more suitable form for storage and processing at the client. For example, the EPG server 110 might be configured to reduce the amount of EPG data, alter the format or structure of the EPG data 104, and/or compress the EPG data.

The EPG server 110 creates different versions of the EPG data for different head end services to account for programming preferences and lineups. For example, the EPG server 110 limits the EPG data to those channels that are relevant to the respective head ends. In the illustrated example, the EPG server 110 creates multiple versions of the EP(G data, which are designated as EPG₁, EPG₂, . . . , EPGₕ, and stores them in respective databases 112(1), 112(2), 112(h). The data center 106 transfers the head end versions of the EPG data as electronic files 114 to associated head end services 120(1), 120(2), . . . , 120(h) using, for example, FTP or other suitable transfer protocols over a network.

At individual head end services, as represented by service 120(1), the EPG data is stored in a head end database 122 A carousel file system 124 repeatedly broadcasts an EPG data file 126 over an out-of-band (OOB) channel on a broadcast network 128 to the clients 130(1), 130(2), . . . , 130(c). The EPG data file 126 might contain all of the EPG data contained in the EPG data file received from the data center 106, or it might contain a subset of the data. That is because the EPG data file 114 received from the data center 106 typically contains more EPG data than can be stored at the client 130. For instance, the EPG data file 114 might contain multiple weeks of EPG data, whereas the client might only be able to store data for a few days. Thus, the carousel file system 124 might be configured to serve a portion of the EPG data deemed to be most relevant to the viewer, such as the current and next few days of EPG data. Alternatively, the EPG file system 124 broadcasts all of EPG data and the individual clients store as much of the EPG data as can be accommodated given their respective storage resources.

Distribution from the head ends 120 to the clients 130 may be accommodated in a number of ways, including cable, RF, microwave, network (e.g., Internet), and satellite. A back channel 132 (e.g., telephone line, two way cable, etc.) provides reverse communication from the clients 130 back to the head end 120(1).

In the illustrated implementation, the clients 130 are embodied as set top boxes (STBs) connected to associated televisions 134(1), 134(2), . . . , 134(c). The clients 130 are often equipped with sufficient processing and storage capabilities to store and run an operating system and a few programs. Examples of programs stored on a client might include a Web browser, an electronic programming guide, a personal scheduler, and so forth. Although the STBs are shown separately from the television sets, they may alternatively be built into the television sets as integral units. Furthermore, in other implementations, the clients may be embodied as other devices capable of handling EPG data, such as a broadcast-enabled computer, an information appliance, or the like.

Low resource clients, such as a set top box, are typically characterized as having limited memory and/or processing resources. Such clients are not typically capable of storing the entire original version of the EPG data. Instead, they often have only enough memory to store a subset of the data. For example, a set top box may only be equipped with 500K bytes of memory, which is sufficient to hold only few days (e.g., 3-5 days). However, viewers are often interested in searching future programs farther out in the future. These programs are part of the EPG data file stored at the carousel file system 124, but may not be stored locally at the client 130.

Accordingly, to facilitate searching at a low resource client, the broadcast architecture supports client-based searching performed at the client 130, with the assistance of the carousel file system 124. The carousel file system 124 reconstructs the EPG data file 114 received from the data center 106 into a searchable data structure that can be searched at the client. Generally, the carousel file system 124 breaks the EPG data file 114 into multiple segments. A hash algorithm is applied to each segment to produce associated hash index values. These values are stored in a segment index table and associated with their corresponding data segments. The segment index table of hash index values is broadcast to the client 130, where it is stored.

When a viewer initiates a search, the client 130 computes a hash of the search query using the same hash algorithm. The client searches the locally stored segment index table and compares the hashed search query with the hash index values for possible matches. When a match is found, the matching index value identifies an associated EPG data segment. The client then pulls the associated EPG data segment off the carousel file system 124, and stores it locally for additional search processing. The EPG data segment may alternatively be transmitted back to the requesting client over the back channel 132. After searching the EPG data segment, the client 130 presents the search results to the viewer.

Exemplary EPG Carousel File System

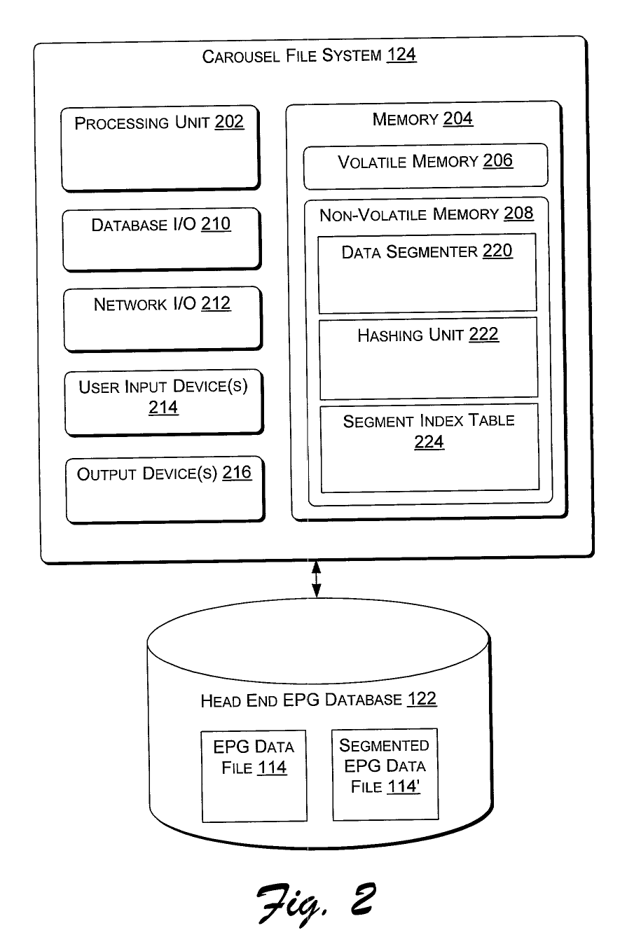

FIG. 2 shows an exemplary implementation of the EPG carousel file system 124. It has a processing unit 202 and memory 204. Memory 204 includes volatile memory 206 (e.g., RAM) and non-volatile memory 208 (e.g., ROM, flash, floppy disk, hard disk, CD-ROM, disk array, etc.). The carousel file system 124 is equipped with a database I/O 210 to interface with the head end EPG database 122 and a network I/O 212 to provide access to one or more networks. The carousel file system 124 may optionally be equipped with one or more input devices 214 (e.g., keyboard, mouse, track ball, touch panel screen, etc.) and one or more output devices 216 (e.g., display, printer, etc.).

The EPG carousel file system 124 is capable of repeatedly broadcasting the EPG data file 114 stored in the head end EPG database 122. The processing unit 202 serves the EPG data file 114 repeatedly over an out-of-band channel to maintain current data at the client. The processing unit 202 may also be configured to encode, encrypt, or otherwise package the EPG data file in some manner to facilitate transmission over the network 128 to the client.

One or more programs are stored in memory 204 and executed on processing unit 202 to process the EPG data. The programs include a data segmenter 220 and a hashing unit 222. The EPG server 110 also runs an operating system (not shown), such as a Windows® brand operating system from Microsoft Corporation, or a Unix-based operating system.

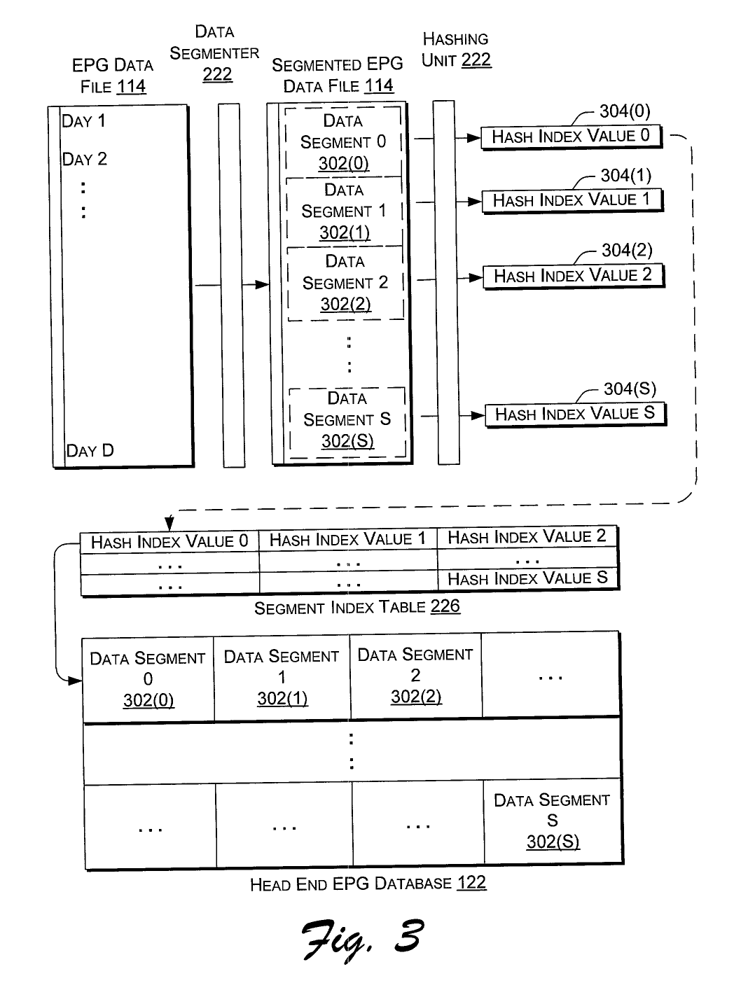

The operation of the carousel file system 124 will now be described with additional reference to FIG. 3. The data segmenter 220 segments the EPG data file 114 into multiple segments 302(0), 302(1), . . . 302(S), forming a modified file structure 114′. The EPG data may be segmented according to time, channel, or some other metric. The segments 302 may or may not be the same size. The segments 302 are stored in the head end EPG database 122.

The carousel file system 124 then derives index values representative of content in corresponding data segments of the broadcast carousel data. In one implementation, each segment 302(0), 302(1), . . . , 302(S) is passed to the hashing unit 222, which computes a corresponding hash index value 304(0), 304(1), . . . 304(S). More specifically, the hashing unit 222 executes a hashing function of the words (or other items, such as numbers, symbols, etc.) in the EPG data segment 302. Example hashing algorithms that may be employed by the hashing unit 222 include SHA (secure hash algorithm), SHJA-1, MD2 (message-digest algorithm, version 2), MD4, and MD5. In one implementation, a hash digest is computed for each and every word in the EPG data segment 302. The resulting word hash digests are combined using a logical OR function to produce a hash index value 304.

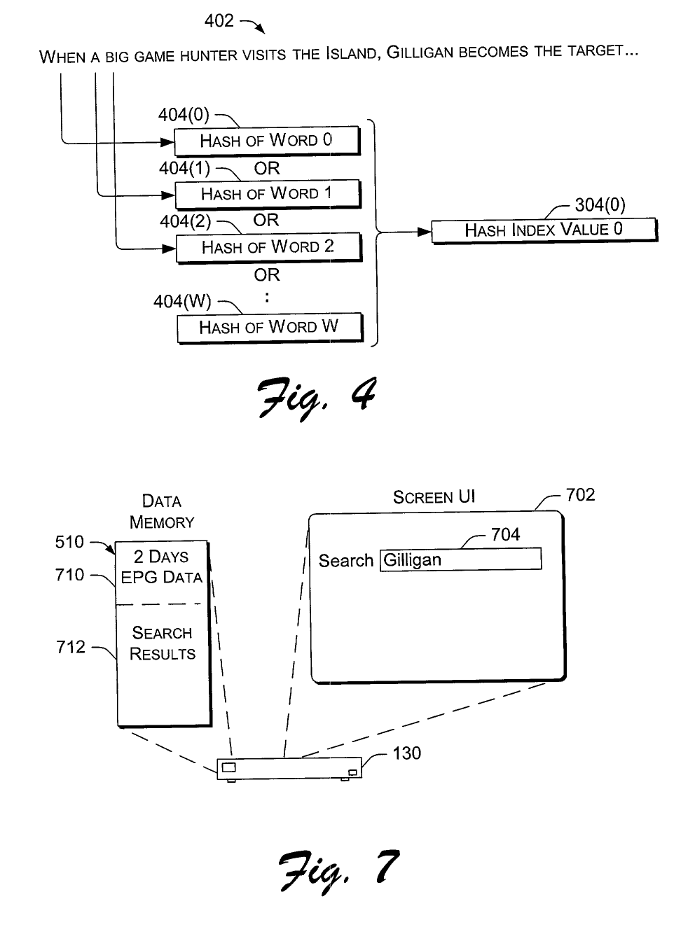

FIG. 4 illustrates this implementation of producing hash index values. Suppose an EPG data segment 302 contains a program description 402 for an episode of Gilligan's Island. The description begins:

When a big game hunter visits the island, Gilligan becomes the target . . .

The hashing function is applied to each word in the description to produce individual word hash digests 404(0), 404(1), 404(2), . . . 404(W). Each digest is the same length and the length is an implementation parameter that varies depending upon the hashing algorithm that is used. Example bit lengths of a hash digest might be 512 bits, or longer. The resulting word hash digests 404 are combined using a logical OR function to produce a hash index value, such as value 304(0). This is represented by the following fictitious example in which the hash digest for the word “island” is OR'd with the hash digest for the word “Gilligan”:

$$\begin{matrix}island \to 1 \; 0 \; 1 \; 0 \; 0 \; 0 \; 0 \; 0 \; 0 \; 1 \; 0 \; 0 … 0 \; 1 \\ \underline{Gilligan \to 0 \; 0 \; 0 \; 1 \; 0 \; 1 \; 0 \; 0 \; 0 \; 0 \; 0 \; 0 … 0 \; 0} \\ {OR}^{′} d Result \to 1 \; 0 \; 1 \; 1 \; 0 \; 1 \; 0 \; 0 \; 0 \; 1 \; 0 \; 0 … 0 \; 1\end{matrix}$$

The hash index values 304(0)-304(S) are stored in a segment index table 224. The hash index values 304(0)-304(S) are correlated via the data structure with their associated EPG data segments 302 so that knowledge of a particular hash index value enables identification of its associated EPG data segment. This is represented diagrammatically in FIG. 3 by the arrow linking the hash index value 0 in the segment index table 224 with the corresponding data segment 0 in the EPG database 122. Once the segment index table is built, the carousel file system 124 repeatedly broadcasts the segment index table 224 to the clients along with the EPG data file 126.

It is noted that the processes carried out by the carousel file system 124 are described as being implemented in software. However, in alternative implementations, some or all of these processes may be implemented in firmware and/or hardware.

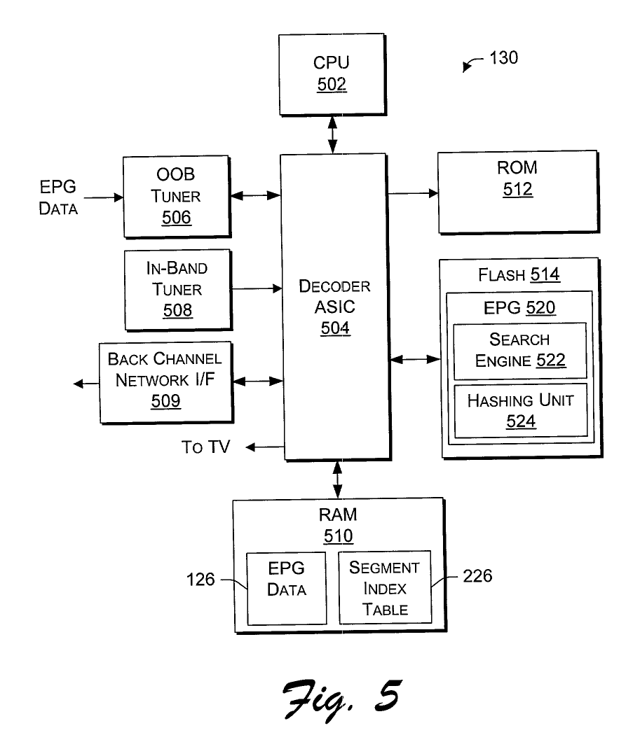

Exemplary Client FIG. 5 shows an exemplary client 130 implemented as a set-top box. The client 130 has a central processing unit (CPU) 502 coupled to a decoder ASIC (application specific integrated circuit) 504. In addition to decoder circuitry, ASIC 504 may also contain logic circuitry, bussing circuitry, and a video controller.

The client 130 further includes an out-of-band (OOB) tuner 506 to tune to the broadcast channel over which the EPG data file 126 is broadcast. One or more in-band tuners 508 are also provided to tune to various television signals. These signals are passed through the ASIC 504 for audio and video decoding and then to an output to the television set. With the tuners and ASIC 504, the client is equipped with hardware and/or software to receive and decode a broadcast video signal, such as an NTSC, PAL, SECAM or other TV system video signal and provide video data to the television set. The client 130 also has a back channel network interface 509 (e.g., modem, ISDN modem, etc.) to support communication back to the carousel file system 124 over back channel 132 (see FIG. 1).

One or more memories are coupled to ASIC 504 to store software and data used to operate the client. In the illustrated implementation, the client 130 has random access memory (RAM) 510, read only memory (ROM) 512, and flash memory 514. RAM 510 stores data used by the client, including all or part of the EPG data file 126 (e.g., data segments for the next two days of programming) and the segment index table 224. ROM 512 stores an operating system (not shown).

One or more programs may be stored in the ROM 512 or in the flash memory 514. In the illustrated example, the flash memory 514 stores an EPG program 520 to operate on the EPG data 126. The EPG program 520 includes a search engine 522 to search the EPG data 126 stored at the in response to queries specified by the viewer. The search engine 522 might be used, for example, to locate particular television shows by title, or find shows with a particular rating, or identify programs with selected actors. The EPG program 520 also has a client-side hashing unit 524 to compute hashing functions on search queries using the same hashing algorithm employed by the server-side hashing unit 222 described above.

When a viewer specifies a search term (e.g., enters a word, selects a predefined search parameter, etc.), the client 130 derives a search query from the search term in the same manner that the carousel file server derives the index values. For instance, the hashing unit 524 computes a hashed search query by hashing the search term according to the same hashing function used by the carousel file system to create the hash index values. The search engine 522 compares the hashed search query with the hash index values 304 in the locally stored segment index table 224 for possible matches. When a match is found, the search engine 522 identifies an associated EPG data segment and pulls the associated EPG data segment off the carousel file system 124 and stores the associated EPG data segment locally. The search engine 522 can then conduct full text searching of the EPG data segment using the viewer-specified search term.

The client 130 may further include other components, which are not shown for simplicity purposes. For instance, the client is typically equipped with hardware and/or software to present a graphical user interface to a viewer, by which the viewer can navigate the EPG, or (if enabled) to access various Internet system network services, browse the Web, or send email. Other possible components might include an IR interface,, display, power resources, etc. A remote control may further be provided to allow the user to control the client.

Searching Operation

Low resource client 130 has limited memory and processing resources. For example, set top boxes are typically manufactured with a fixed amount of memory that satisfies the manufacturer's price/performance criteria. A portion of this memory is allocated to hold EPG data. The amount of EPG data to be transmitted down to the set top box might be expected to consume, for example, no more than 500K bytes of memory. This correlates to approximately 3-5 days worth of EPG data. However, viewers are often interested in searching future programs that are further out in the future. This involves searching data that may or may not be resident at the client, but is resident at the carousel file system. Thus, to facilitate searching of carousel broadcast data that may not be local to the client, the broadcast architecture supports a searching process that is performed at the low resource client with the assistance of the carousel file system.

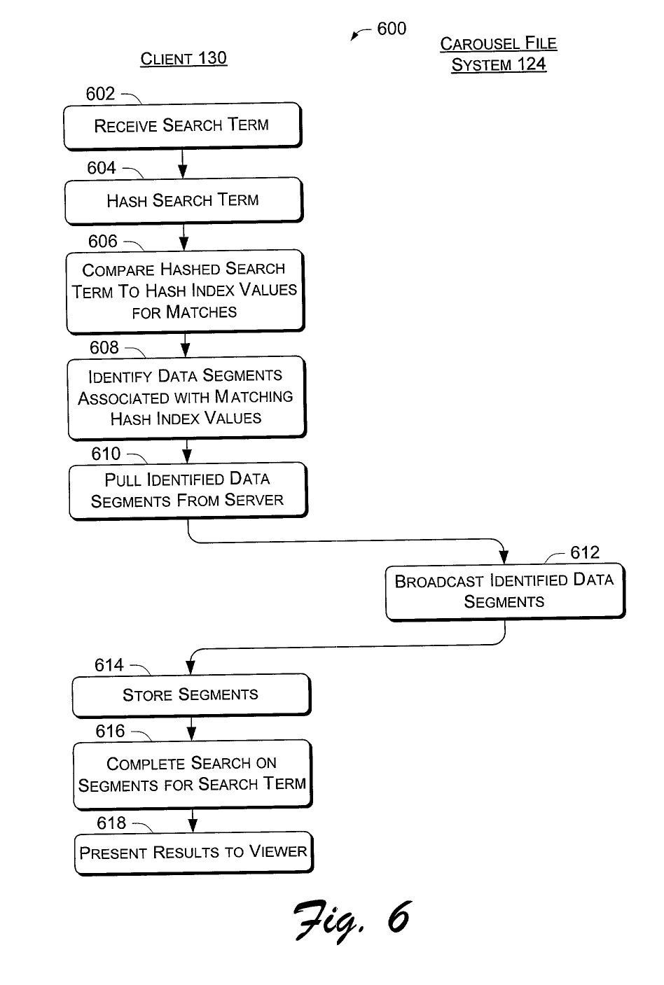

FIG. 6 shows one example of a client-based searching process 600 supported by the broadcast architecture. The process 600 may be implemented in software, firmware, hardware, or a combination of these. In the case of software and firmware, process 600 represents a set of operations that may be implemented as computer-executable instructions that can be executed by a processor, such as processors employed by the client 130 and the carousel file system 124. The is operations are aligned visually beneath headings to illustrate one possible implementation as to which operations are performed by which computing devices.

At block 602, the client receives a search term entered or selected by the viewer. This operation is illustrated in FIG. 7. The client EPG program 520 presents a screen-based user interface (UI) 702 that allows a viewer to enter a search term into a field 704. In keeping with our ongoing example, suppose the viewer enters the word “Gilligan” in the hopes of finding episodes of “Gilligan's Island”.

At block 604, the client-based hashing unit 524 computes a hash digest of the search term. The hashing unit 524 employs the same hashing function as is used by the carousel file system 124. At block 606, the client 130 compares the hashed search query with the hash index values 304 in the segment index table 224 that is stored locally. In our example, the hashed search term for “Gilligan” will match at least the hash index value constructed, in part, from the program description 402.

Gilligan 0 0 0 1 0 1 0 0 0 0 0 0 . . . 0 0

Index Value 1 0 1 1 0 1 0 0 0 1 0 0 . . . 0 1

The number of matching hash index values, if any, will depend in part on the uniqueness of the search query. If the search returns many hits, the viewer may be requested to refine the search query with additional terms. Suppose, however, that the search term “Gilligan” matches at least one hash index value.

At block 608, the one or more matching hash index value are used to identify one or more corresponding EPG data segments 302. The associated EPG s data segments may already reside at the client. If this is the case, the client may simply continue searching the data segments using the search term. But, more likely, the associated EPG data segments will reside at the carousel file system.

At blocks 610 and 612, the client 130 selectively retrieves the one or more identified EPG data segments as they are broadcast over the network from the carousel file system 124. Alternatively, in response to a client request, the carousel file system 124 may return the identified EPG data segment(s) to the client over the back channel 132.

At block 614, the client stores the data segments in data memory 510. In one implementation, the client 130 allocates a portion of its memory to store the identified EPG data segments. As illustrated in FIG. 7, the client 130 allocates a first portion of memory 510 to store a subset of the EPG data (e.g., a couple days of programming) that is broadcast from the carousel file system 124. A second portion of memory 510 is then allocated to store the data segments returned as results to the viewer-initiated search. The client-based search engine 522 can then complete the search on the stored EPG data segments (block 616). The search engine 522 compares the original input query (e.g., “Gilligan”) to the newly stored EPG data segments for any content that matches the query. As an example, the search engine performs full text searching, comparing the search term to the words in the segments. At block 618, results from this search, if any, are presented to the viewer in the user interface 702.

It is noted that, due to the nature of hashing functions, a match between the hashed search query and a hash index value does not necessarily mean that the corresponding EPG data segment will contain content satisfying the query. There can be false positives. However, the search does ensure data segments associated with non-matching hash index values will not satisfy the query. Accordingly, the hashing-based distributed searching operation exhibits the following search properties:

A match between a hash index value and the hashed search query does not necessarily imply that the EPG data segment associated with the hash index value contains content satisfying the query. The associated EPG data may or may not contain content satisfying the query.

A non-match between a hash index value and the hashed search query necessarily ensures that the associated EPG data segment will not satisfy the query.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. In a broadcast architecture in which a carousel file server broadcasts carousel data to one or more clients, a method implemented at the client comprising:
receiving an index data structure :from the carousel file server, the index data structure having index values derived from content in corresponding segments of the broadcast carousel data;
searching the index data structure to identify one or more particular segments of the broadcast carousel data for further searching; and
retrieving the one or more particular segments from the carousel file server.

2. A method as recited in claim 1, wherein the broadcast carousel data comprises data for an electronic program guide.

3. A method as recited in claim 1, wherein the index values are derived by applying a hashing function to the corresponding segments of the broadcast carousel data.

4. A method as recited in claim 1, further comprising searching the one or more particular segments after they are retrieved.

5. A method as recited in claim 1, further comprising allocating a first portion of memory to store at least part of the broadcast carousel data and a second portion of the memory to store the one or more particular segments retrieved from carousel file server.

6. A computer-readable medium comprising computer-executable instructions that, when executed, direct a computing device to perform the method as recited in claim 1.

7. In a broadcast architecture in which a carousel file server broadcasts ii carousel data to one or more clients, a method implemented at the client comprising:
receiving broadcast carousel data and an index data structure from the carousel file server, the index data structure having index values associated with corresponding portions of the broadcast carousel data, the index values being derived from the portions of the broadcast carousel data;
storing the index data structure and at least part of the broadcast carousel data;
deriving a query from a search term in a same manner that the index values were derived from the portions of the broadcast carousel data;
comparing the query to the index values in the index data structure;
in an event that the query matches a particular index value, identifying a particular portion of the broadcast carousel data associated with the particular index value;
retrieving the particular portion of the broadcast carousel data from the carousel file server; and
searching the particular portion of the broadcast carousel data using the search term.

8. A method as recited in claim 7, wherein the broadcast carousel data comprises data for an electronic program guide.

9. A method as recited in claim 7, wherein the index values are derived by computing a hashing function of the corresponding portions of the broadcast carousel data, and the deriving a query comprises computing the hashing function of the search term to produce the query.

10. A method as recited in claim 7, wherein the searching comprises performing full text searching on the particular portion of the broadcast carousel data.

11. A method as recited in claim 7, further comprising allocating a first portion of memory to store at least part of the broadcast carousel data and a second portion of the memory to store the particular portion of the broadcast carousel data.

12. A computer-readable medium comprising computer-executable instructions that, when executed, direct a computing device to perform the method as recited in claim 7.

13. A method for searching carousel data that is broadcast from a carousel server to one or more clients, comprising:
at the carousel server:
storing carousel data to be broadcast;
constructing an index data structure having index values associated with corresponding data segments of the carousel data, the index values being derived from the corresponding data segments;
broadcasting the carousel data and the index data structure to one or more clients;
at a client:
storing a subset of the carousel data and the index data structure;
deriving a search query from a search term specified by a viewer to search the carousel data;
comparing the search query to the index values in the index data structure;
in an event that the query matches a particular index value, identifying a particular data segment associated with the particular index;
retrieving the particular data segment as the carousel data is broadcast from the carousel sever; and
searching the particular data segment using the search term.

14. A method as recited in claim 13, wherein the carousel data comprises data for an electronic program guide.

15. A method as recited in claim 13, wherein the constructing comprises:
segmenting the carousel data into multiple data segments;
computing a hashing function on individual data segments to produce corresponding hash index values that are representative of the data segments; and
forming the index data structure to associate the hash index values with corresponding data segments.

16. A method as recited in claim 13, wherein the index values and the search query are derived using a hashing function.

17. A method as recited in claim 13, wherein, for each data segment, the index value in the index data structure associated with the data segment is derived by:
producing hash digests for individual items in the data segment; and
combining the hash digests for individual items using a logical OR operation.

18. A method as recited in claim 17, wherein the deriving a search query comprises computing a hash digest of the search term to produce the search query.

19. A method as recited in claim 13, further comprising, at the client, allocating a first portion of memory to store at least part of the carousel data broadcast from the carousel server and a second portion of the memory to hold the particular data segment.

20. A method as recited in claim 13, further comprising, at the client, presenting any results of the searching to the viewer.

21. Computer-readable media comprising computer-executable instructions that, when executed, direct computing devices to perform the method as recited in claim 13.

22. A method comprising:
segmenting data to be broadcast by a carousel file system into multiple data segments;
computing a hashing function on individual data segments to produce corresponding hash values that are representative of the data segments; and
forming a data structure that associates the hash values with corresponding data segments.

23. A method as recited in claim 22, wherein the data comprises data for an electronic program guide.

24. A method as recited in claim 22, wherein the segmenting comprises dividing the data into equal-size data segments.

25. A method as recited in claim 22, wherein the computing comprises, for each data segment:
producing hash digests of terms in the data segment; and
forming a hash value for the data segment by combining the hash digests using a logical OR operation.

26. A method as recited in claim 22, further comprising broadcasting the data structure to one or more clients for use in performing data searches on the In data.

27. Computer-readable media comprising computer-executable instructions that, when executed, direct computing devices to perform the method as recited in claim 22.

28. A computer-readable medium comprising computer-executable instructions that, when executed, direct a computing device to:
derive a search query as a function of a search term;
compare the search query to multiple index values representative of associated segments of broadcast carousel data that are broadcast by a carousel file system, the index values being derived from the associated segments of broadcast carousel data using the function;
in an event that the query matches a particular index value, identify a particular segment of the broadcast carousel data associated with the particular index value;
retrieve the particular segment from the carousel file system; and
search the particular segment using the search term.

29. A computer-readable medium as recited in claim 28, further comprising computer-executable instructions that, when executed, direct the computing device to derive the search query using a same hashing function as is used to derive the index values from the associated segments of the broadcast carousel data.

30. A computer-readable medium as recited in claim 28, further comprising computer-executable instructions that, when executed, direct the computing device to perform full text searching on the particular segment using the search term.

31. A computer-readable medium as recited in claim 28, further comprising computer-executable instructions that, when executed, direct the computing device to allocate a first portion of memory to store at least part of the broadcast carousel data and a second portion of the memory to store the particular segment.

32. A computer-readable medium comprising computer-executable instructions that, when executed, direct a computing system to:
segment a data file to be broadcast by a carousel file system into multiple data segments;
produce hash index values from corresponding data segments by applying a hashing function to the corresponding data segments; and
construct a data structure that associates the hash index values with the corresponding data segments.

33. A computer-readable medium as recited in claim 32, further comprising computer-executable instructions that, when executed, direct the computing system to divide the data into equal-size data segments.

34. A computer-readable medium as recited in claim 32, further comprising computer-executable instructions that, when executed, direct the computing system to:
produce hash digests of terms in the data segment; and
compute a hash value for the data segment by combining the hash digests using a logical OR operation.

35. A computer-readable medium as recited in claim 32, further comprising computer-executable instructions that, when executed, direct the computing system to broadcast the data structure to one or more clients for use in performing data searches on the data file.

36. For a broadcast architecture in which a carousel server repeatedly broadcasts a data file to one or more clients, computer-readable media comprising computer-executable instructions that, when executed, direct one or more computing devices to:
construct an index data structure having index values associated with corresponding data segments of the data file, the index values being derived from the corresponding data segments using a hashing function;
broadcast the data file and the index data structure to a client;
store the index data structure and at least a portion of the data file at the client;
derive a search query to search the data file, the search query being derived from a viewer-specified search term using the hashing function;
compare the search query to the index values in the index data structure;
in an event that the search query matches a particular index value, identify a particular data segment of the data file that is associated with the particular index value;
store the particular data segment at the client; and
search the particular data segment using the search term.

37. Computer-readable media as recited in claim 36, further comprising computer-executable instructions that, when executed, direct one or more computing devices to allocate a first portion of client memory to store at least part of the data file and a second portion of the client memory to store the particular data segment.

38. Computer-readable media as recited in claim 36, further comprising computer-executable instructions that, when executed, direct one or more computing devices to present search results to a viewer.

39. A client computing device comprising:
a memory to store part of a broadcast data file broadcast by a carousel file server and an index data structure, the index data structure having index values associated with corresponding portions of the broadcast data file, the index values being derived from the portions of the broadcast data file such that the index values are representative of content in the corresponding portions; and
a processor coupled to the memory to receive a search term for searching the broadcast data file, the processor deriving a search query from the search term and determining whether one or more index values match the search query, whereupon finding a match, the processor identifies one or more portions of the broadcast data file that correspond to each matching index value and retrieves the one or more portions of the broadcast data file from the carousel file server for storage in the memory and further searching using the search term.

40. A client computing device as recited in claim 39, wherein the processor allocates a first portion of the memory to store the part of the broadcast data file and allocates a second portion of the memory to store the one or more portions of the broadcast data file that corresponds to each matching index value.

41. A client computing device as recited in claim 39, wherein the broadcast data file comprises data for an electronic program guide.

42. A client computing device as recited in claim 39, wherein the index values are derived by computing a hashing function of the corresponding portions of the broadcast data file, and the processor derives the search query by computing the hashing function of the search term.

43. A client computing device as recited in claim 39, wherein the processor performs full text searching on the one or more portions of the broadcast data file.

44. A client computing device as recited in claim 39, embodied as a set top box.

45. A processing system, comprising:
reception means for receiving carousel data and an index data structure from a carousel file system, the index data structure having index values associated with corresponding segments of the carousel data, the index values being derived from the segments of the carousel data;
storage means for storing the index data structure and part of the carousel data; and
search means for searching the carousel data by generating a query from a search term and comparing the query to the index values in the index data structure, whereupon if the query matches a particular index value, identifying a particular segment of the carousel data associated with the particular index value for reception by the reception means and storage by the storage means, the search means being configured to search the particular segment using the search term.

46. A processing system as recited in claim 45, wherein the carousel data comprises data for an electronic program guide.

47. A processing system as recited in claim 45, wherein storage means has a first portion allocated to store the part of the carousel data and a second portion allocated to store the particular segment.

48. A processing system as recited in claim 45, wherein the search means performs full text searching on the particular segment.

49. A processing system as recited in claim 45, wherein the index values are derived using a hashing function applied to the associated segments of the carousel data, and the search means comprises hashing means for hashing the search term according to the hashing function to generate the query.

50. An electronic program guide (EPG) server, comprising
a memory to store an EPG data file;
a processor coupled to the memory to serve the EPG data file to one or more clients;
a data segmenter stored in the memory and executed on the processor to segment the EPG data file into multiple data segments;
a hashing unit stored in the memory and executed on the processor to derive hash digests of corresponding data segments and store the hash digests in a segment index table such that the hash digests reference the corresponding data segments; and
wherein the processor further serves the segment index table to the one or more clients.

51. An EPG server as recited in claim 50, wherein, for each data segment, the hashing unit derives the hash digest by hashing individual items in the data segment and logically combining results of the hashing using a logical OR operation.

52. A processing system, comprising:
segmentation means for segmenting data to be broadcast by a carousel file system into multiple data segments;
hashing means for computing a hashing function of the data segments to produce corresponding hash values that ;are representative of the data segments; is and
broadcasting means for broadcasting the data and the hash values representative of the data segments to one or more clients.

53. A processing system as recited in claim 52, wherein the hashing means is configured to produce a hash digest of each term in the data segment and form a hash value for the data segment by combining the hash digests using a logical OR operation.

54. A television entertainment s stem, comprising:
an EPG server to segment the electronic program guide (EPG) data file into multiple data segments and hash individual data segments according to a hashing function to form hash index values representative of the data segments, the EPG server being configured to broadcast the EPG data file and the hash index values; and
a client to receive the EPG data file and the hash index values, the client having memory to store the hash index values and at least part of the EPG data file, the client being configured to derive a hashed search query by hashing a search term using the hashing function and to compare the hashed search query to the hash index values, whereupon finding a match, the client identifies the data segment represented by the matching hash index value and retrieves the identified data segment from the EPG server.

55. A television entertainment system as recited in claim 54, wherein the EPG server forms each hash index value by hashing individual items in the data segment and combining the hashed individual elements using a logical OR operation.

56. A television entertainment system as recited in claim 54, wherein the client searches the identified data segment using the search term.

57. A data structure stored on a computer-readable medium, comprising:
multiple data segments segmented from a carousel data file to be broadcast by a carousel file system;
a segment index table containing hash index values that reference corresponding data segments; and
wherein the hash index values are derived as a hashing function of the corresponding data segments.

58. A data structure as recited in claim 57, wherein each hash index value is derived by computing hash digests of individual items in the corresponding data segment and combining the hash digests using a logical OR operation.
